(19) United States
(12) Patent Application Publication
(10) Pub. No.: US 2006/0036861 A1
(43) Pub. Date: Feb. 16, 2006

(54) Method and apparatus for algebro-geometric key establishment protocols based on matrices over topological monoids

(76) Inventors: Leon Chernyak, Sharon, MA (US); Arkady Berenstein, Eugene, OR (US)

Correspondence Address: LEON CHERNYAK, 112 ACADEMY HILL RD. #1, BRIGHTON, MA, 02135, US

(21) Appl. No.: 11/160,491

(22) Filed: Jun. 27, 2005

Related U.S. Application Data
(60) Provisional application No. 60/521,795, filed on Jul. 4, 2004.

(51) Int. Cl. H04L 9/00

(52) U.S. Cl. 713/171

(57) ABSTRACT

The present invention proposes a continuous multi-parameter version of Diffie-Hellman protocol based on matrices over topological monoids. In its turn, based on this continuous protocol, a method for public establishment and distribution of keys for encryption systems is implemented. An embodiment of the method, while providing a high security level, is several orders of magnitude faster than the existing key establishment systems. The present invention is a further development of the method of the geometric key establishment first proposed in U.S. patent application Ser. No. 10/708,197 by A. Berenstein and L. Chernyak.

### REFERENCES CITED

U.S. Pat. No. 5,696,826, December 1997, by Gao.
U.S. Pat. No. 6,493,449, December 2002, by Anshel et al;
U.S. patent application Ser. No. 10/605,935 by Berenstein and Chernyak.
U.S. patent application Ser. No. 10/708,197 by Berenstein and Chernyak.

### OTHER REFERENCES

B. Schneier, “Applied Cryptography” 1994, John Wiley & Sons pp. 241, FIG. 10.5. D. Boneh. The decision Diffie-Hellman problem. In Proceedings of the Third Algorithmic Number Theory Symposium, Lecture Notes in Computer Science, Vol. 1423, Springer-Verlag, pp. 48-63, 1998.

### BACKGROUND OF INVENTION

1. Field of the Invention

The invention relates to key establishment and distribution algorithms for cryptographic applications.

2. Description of the Prior Art: Key Establishment Protocols

The concepts, terminology and framework for understanding cryptographic key establishment protocols is given in Alfred J. Menezes, Paul C. van Oorschot, and Scott A. Vanstone, “Handbook of Applied Cryptography,” CRC Press (1997), pages 490-491.

A ‘protocol’ is a multi-party algorithm, defined by a sequence of steps specifying the actions required of two or more parties in order to achieve a specified objective.

A ‘key establishment’ protocol is a protocol whereby a shared secret becomes available to two or more parties, for subsequent cryptographic applications.

A ‘key transport’ protocol is a key establishment protocol where one party creates or obtains a secret value, and securely transfers it to the other participating parties.

A ‘key agreement’ protocol is a key establishment protocol in which a shared secret is derived by two (or more) parties as a function of information contributed by, or associated with, each of the participating parties such that no party can predetermine the resulting value.

A ‘key distribution’ protocol is a key establishment protocol whereby the established keys are completely determined a priori by initial keying material.

The Diffie-Hellman key establishment protocol (also called ‘exponential key exchange’) is a fundamental algebraic protocol. It is presented in W. Diffie and M. E. Hellman, “New Directions in Cryptography,” IEEE Transaction on Information Theory vol. IT 22 (November 1976), pp. 644-654. The Diffie-Hellman protocol provided the first practical solution to the key distribution problem, allowing two parties, never having met in advance or sharing keying material, to establish a shared secret by exchanging messages over an open channel.

The security of this protocol rests on the intractability of the Diffie-Hellman problem and the related problem of computing discrete logarithms in the multiplicative group of the finite field GF(p) where p is a large prime, cf. Alfred J. Menezes, Paul C. van Oorschot, and Scott A. Vanstone, “Handbook of Applied Cryptography,” CRC Press (1997), page 113.

Most of known applications of Diffie-Hellman protocol deal with finite groups. Recently there emerged versions of Diffie-Hellman protocol for infinite, but yet discrete groups (see for example, U.S. Pat. No. 6,493,449 by Anshel et al), and U.S. patent application Ser. No. 10/708,197 by Berenstein and Chernyak.

Unlike approaches existing in the prior art, the present invention is based not on finite or discrete groups, but rather on the connected compact topological groups.

Brief Overview of Connected Compact Topological Groups

The basic reference for concepts, terminology and historical framework in topological semigroups and monoids are given in the monograph by J. H. Carruth and J. A. Hildebrant, The Theory of Topological Semigroups, Marcel Dekker, Inc., New York, 1983; the basic reference for concepts, terminology and historical framework in topological groups are given in the monographs by P. J. Higgins, Introduction to topological groups, Cambridge: University Press, 1974, and by John F. Price, Lie groups and compact groups, Cambridge [Eng.]; New York: Cambridge University Press, 1977.

A semigroup (X,·) is defined as a set X together with a binary operation X×X→X satisfying the following axiom of associativity. For all x, y, z∈X, (x·y)·z=x·(y·z).

A semigroup (X,·) is called a monoid if it has a unique element 1 (called the unit element) such that x·1=1·x=x.

Any semigroup (X′,·) can be turned into a monoid (X,·) by formally adjoining 1, i.e., X=X′∪{1}. Therefore, it makes sense to speak only about monoids, rather than semigroups.

A monoid (X,·) is called commutative if x·y=y·x for all x, y, z∈X. Typically for commutative monoids the operation of multiplication is written as addition: x+y and the unit element is usually denoted as 0ₓ (and referred to as the neutral additive element).

A topological monoid X is a monoid which is also a topological space such that the multiplication X×X→X is a continuous map. (Here, X×X is viewed as a topological space by using the product topology).

A topological monoid X is called compact if the underlying topological space is compact, i.e., if any open cover of the space X has a finite sub-cover.

A first example of a topological monoid, which is not a group, is given by the extended real line, i.e., all real numbers with the ideal element +∞ and with the operation of addition given by the formula:
x⊕y=min(x, y);
as defined, this monoid possesses the neutral additive element 0ₓ=+∞ (here we follow the standard convention that x+∞=+∞ and min(x,+∞)=x for any real number x). Please note that this monoid is not a group because x⊕x=x for any x. This topological monoid is sometimes referred to as the tropical monoid.

A group (G,·) is a monoid such that for each element g in G there is a unique inverse element g⁻¹:
g·g⁻¹=g⁻¹·g=1.

A topological group G is a group which is also a topological space such that the group multiplication G×G→G and the operation of taking inverses G→G are continuous maps. (Here, G×G is viewed as a topological space by using the product topology.)

A topological group G is called compact if the underlying topological space is compact, i.e., if any open cover of the space G has a finite sub-cover.

A first example of compact topological groups is any finite group (equipped with the discrete topology). Such groups provide examples of compact disconnected topological groups.

Another class of compact topological groups is connected compact topological groups. A topological group is connected if the underlying topological space is connected. This class contains such groups as SO(V), where SO(V) is the group of all special orthogonal transformations of a Euclidean vector space V (therefore, there are at least as many compact connected topological groups as there are Euclidean vector spaces).

The present invention implements the ideas and algorithms of Diffie-Hellman protocol for the case of connected compact topological groups. This approach allows one to bypass and, in some cases, to completely eliminate the computational complexity of the exponentiation operation. Such an approach does not exist in the prior art.

### SUMMARY OF THE INVENTION

Algebro-geometric key establishment system of the present invention allows for easy, secure, and rapid creation and distribution of encryption/decryption keys for major cryptosystems. The procedures of creation and distribution of keys are performed extremely rapidly and have very low computer memory requirements.

The present invention proposes a continuous version of Diffie-Hellman protocol. Based on this continuous Diffie-Hellman protocol, a method for public distribution of keys for encryption/decryption systems is implemented. An embodiment of the method, while providing an high security level, is several orders of magnitude faster than existing key distribution systems.

In one embodiment, the key creation process of the system hereof uses the operation of linear combination with integer coefficients of irrational numbers and the operation of taking fractional parts of real numbers. In more advanced implementations the operation of taking fractional parts can be replaced by the exponentiation from the compact Lie algebra into the corresponding compact Lie group.

In another embodiment, the key creation process of the system hereof uses the operation of addition of real numbers and of taking minimum of several real numbers.

The system of the present invention constructs encryption/decryption keys on the fly out of a publicly chosen m×n-matrix g which coefficients belong to a given topological monoid X and a pair (A, B), where A is a secret integer m×m matrix generated by the first communicating party and B is a secret integer n×n matrix generated by the second communicating party. Absolute values of matrix coefficients of these matrices are bounded by a publicly available constant 10^{N} that may be arbitrarily big. Thus the keys created and distributed by the system hereof can be of any size given in advance. The present invention combines the idea of Diffie-Hellman protocol of key distribution with the idea of the geometric cryptosystem developed in the U.S. patent application Ser. No. 10/605,935 entitled GEOMETRY-BASED SYMMETRIC CRYPTOSYSTEM METHOD by the authors Arkady Berenstein and Leon Chernyak, and the idea of the geometric cryptosystem developed in the U.S. patent application Ser. No. 10/708,197 entitled METHOD AND APPARATUS FOR GEOMETRIC KEY ESTABLISHMENT PROTOCOLS BASED ON TOPOLOGICAL GROUPS by the authors Berenstein and Chernyak.

### BRIEF DESCRIPTION OF THE DRAWINGS

FIG. 1 is a block diagram of the mathematical apparatus that can be used in practicing embodiments of the invention.

FIGS. 2 and 3 are flow diagrams of the algebro-geometric key establishment system which shows the operation of action of matrices with coefficients in a given semi-ring A, on matrices which coefficients belong to a given commutative topological monoid X; when taken with the subsidiary flow diagrams referred to therein, can be used in implementing embodiments of the invention.

FIG. 4 is a flow diagram of the algebro-geometric key establishment system which shows the operation of fractional multiplication of integer m×m matrices by real m×n matrices; when taken with the subsidiary flow diagrams referred to therein, can be used in implementing fractional embodiments of the invention.

FIG. 5 is a flow diagram of the algebro-geometric key establishment system which shows the operation of fractional multiplication of m×n matrices of real numbers by integer n×n matrices; when taken with the subsidiary flow diagrams referred to therein, can be used in implementing fractional embodiments of the invention.

FIG. 6 is a block diagram of the algebro-geometric key establishment system that can be used in practicing fractional m×n-dimensional embodiments of the invention.

FIG. 7 is a block diagram of the algebro-geometric key establishment system that can be used in practicing preferred fractional m×n-dimensional embodiments of the invention in the case when the monoid operation consists of taking the fractional part of sum of real numbers.

FIG. 8 is a block diagram of the algebro-geometric key establishment system that can be used in practicing preferred tropical m×n-dimensional embodiments of the invention in the case when the monoid operation consists of taking the minimum of two real numbers.

### DETAILED DESCRIPTION OF THE PREFERRED EMBODIMENT

The key creation and distribution techniques of an embodiment of the algebro-geometric key establishment system hereof are based on actions of semi-rings on topological monoids. In one embodiment (referred to as a fractional embodiment) this action consists of an action of the semi-ring of positive integers on the semi-open unit interval by multiplication followed by evaluation of fractional parts of real numbers. More specifically, the fractional m×n-dimensional embodiment of the system hereof is based on the operation of multiplication of real matrices by integer matrices and on the operation of evaluating fractional parts of coefficients of resulting matrices.

In more advanced implementations the operation of evaluating fractional parts can be replaced by the exponentiation from the compact Lie algebra into the corresponding compact Lie group.

In another embodiment (referred to as a tropical embodiment) this action consists of a multiplication in the semi-ring consisting of all real numbers and the ideal element +∞ with the tropical addition and multiplication: x⊕y=min(x, y), x∘y=x+y; More specifically, the tropical m×n-dimensional embodiment of the system hereof is based on the operation of the tropical multiplication of matrices which coefficients are reals or +∞.

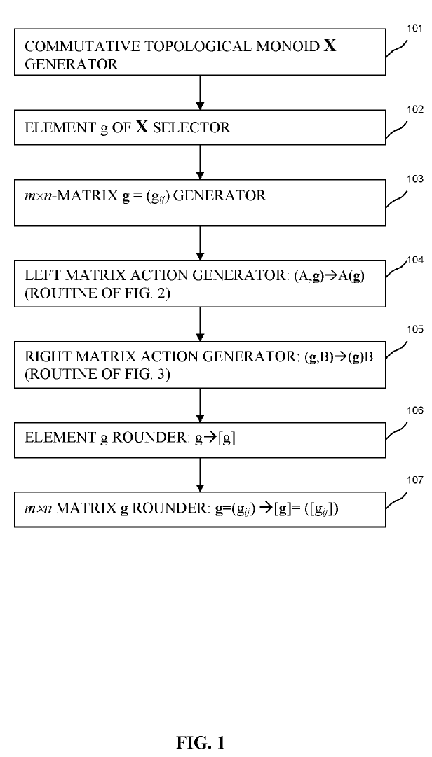

A preferred exemplary embodiment of such an apparatus is depicted with block diagram in FIG. 1, and is described as follows.

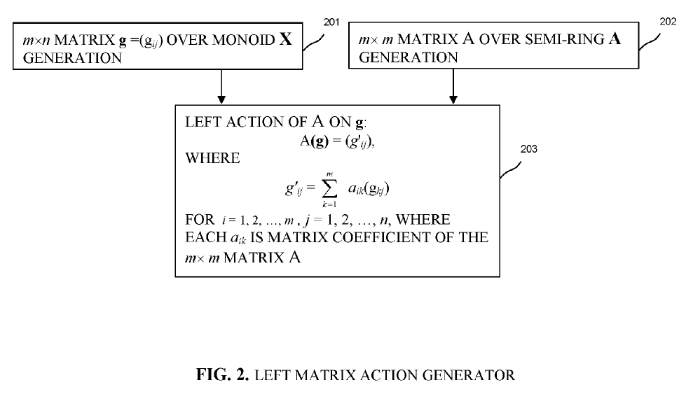

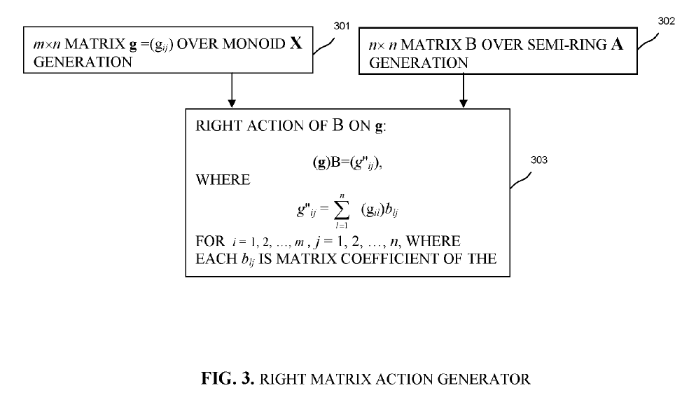

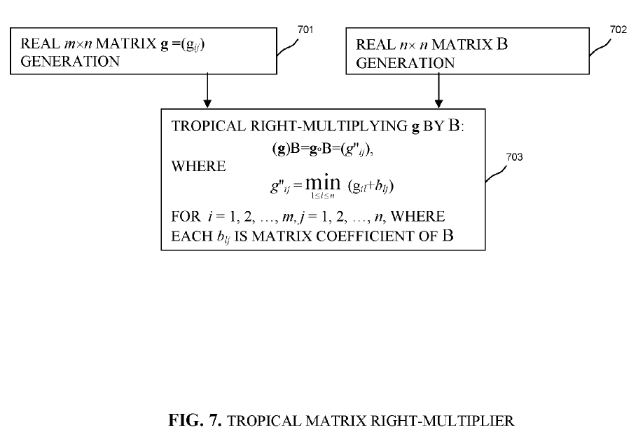

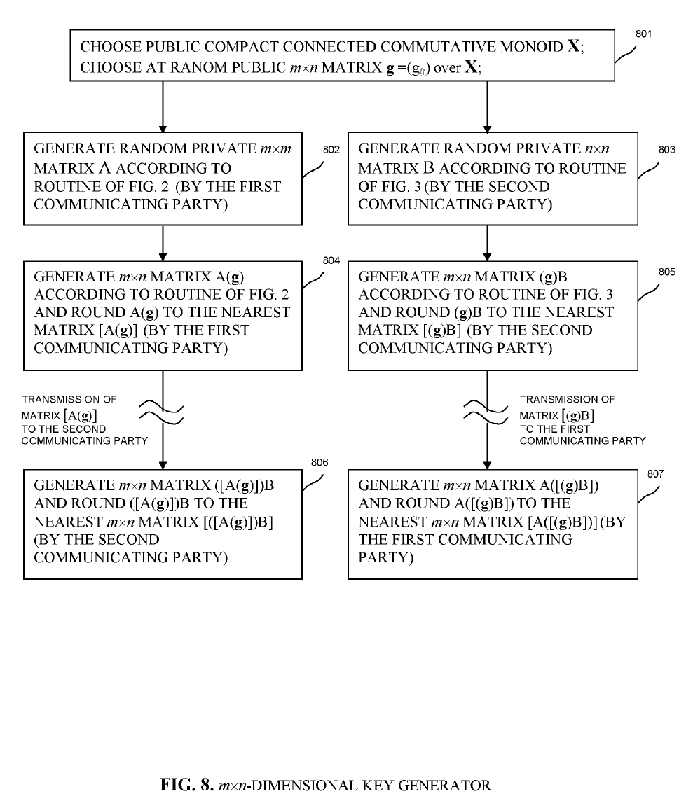

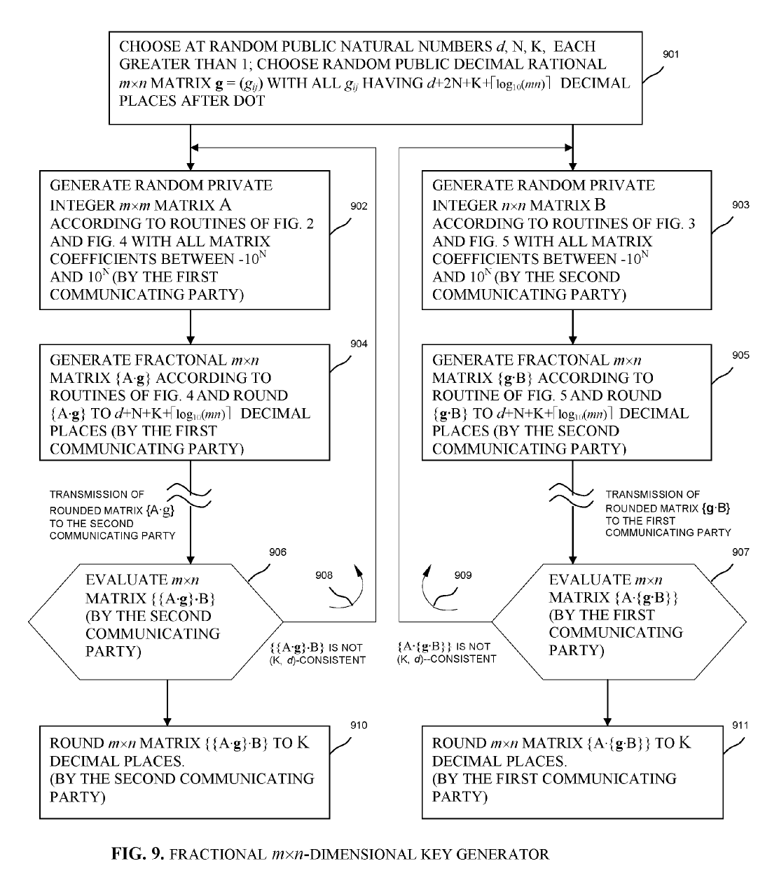

Let X be a commutative topological monoid whose law of composition X×X→X is feasibly computable. There are among such monoids a tropical one (based on the real numbers and +∞), commutative topological groups, e.g., commutative compact topological groups such as closed commutative subgroups in the special orthogonal groups or in the unitary groups. The block 101 generates such commutative topological monoids. Since each such monoid has uncountably many elements, the block 102 selects an element g of X essentially at random. The block 103 generates an m×n matrix g=(gᵢⱼ) which coefficients gᵢⱼ belong to to X. The block 104 is designed for the action of a m×m matrix A=(aᵢₖ) which coefficients belong to a given semi-ring A on the m×n matrix g, which procedure is depicted in more details in FIG. 2. The block 105 is designed for the action of a n×n matrix B=(bₗⱼ) which coefficients belong to the semi-ring A on the m×n matrix g, which procedure is depicted in more details in FIG. 3. The block 106 rounds (if necessary) each element g of the monoid X to the nearest element [g] of X. This procedure is depicted in more details in the subsequent flow diagram of FIG. 7 where, as a preferred fractional embodiment of the invention hereof, the monoid X is a group, which operation consists of taking the fractional part of sum of real numbers. The block 107 applies the procedure of rounding of the block 106 to each coefficient of a given m×n matrix g=(gᵢⱼ).

FIG. 2 represents a basic procedure of the left action of an m×m matrix A=(aᵢₖ) on an m×n matrix g=(gᵢⱼ).

In the block 201 an m×n matrix g=(gᵢⱼ) which coefficients belong to the topological monoid X is generated.

Independently, in the block 202 an m×m matrix A with coefficients in a given semi-ring A is generated.

And, in the block 203 the m×n matrix A(g) is computed according to the formula:

$$A ( g ) = ( {{g}^{′}}_{ij} ) , \\ where$$

$${{g}^{′}}_{ij} = {\sum }_{k = 1}^{m} {a}_{ik} ( {g}_{kj} ) ;$$

for i=1, 2, . . . , m, and j=1, 2, . . . , n.

FIG. 3 represents a basic procedure of the right action of an n×n matrix B=(bₗⱼ) on an m×n matrix g=(gᵢⱼ).

In the block 301 an m×n matrix g=(gᵢⱼ) which coefficients belong to the topological monoid X is generated.

Independently, in the block 302 an n×n matrix B with coefficients in a given semi-ring A is generated.

And, in the block 303 the m×n matrix (g)B is computed according to the formula:

$$g ( B ) = ( {{g}^{″}}_{ij} ) , \\ where$$

$${{g}^{″}}_{ij} = {\sum }_{l = 1}^{n} ( {g}_{il} ) {b}_{lj}$$

for i=1, 2, . . . , m, and j=1, 2, . . . , n.

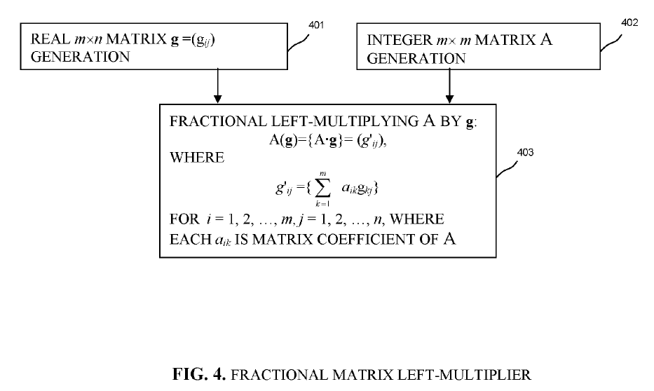

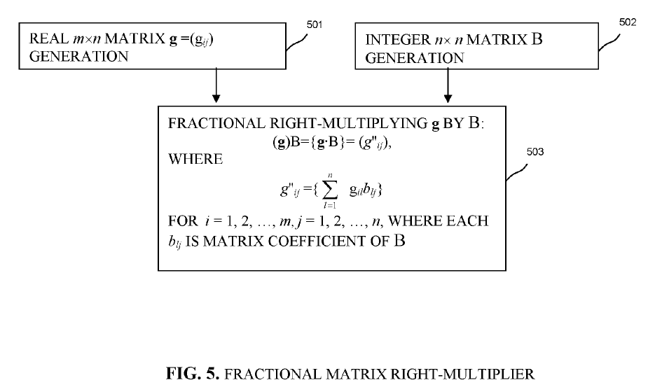

FIG. 4 represents a basic procedure of implementing the routine of FIG. 2 in the case when the monoid operation consists of taking the fractional part of sum of real numbers.

In the block 401 a real m×n matrix g=(gᵢⱼ) is generated.

Independently, in the block 402 an integer m×m matrix A is generated.

And, in the block 403 the fractional product {A·g} is computed according to the formula:

$$\{ A \cdot g \} = ( {{g}^{′}}_{ij} ) , \\ where$$

$${{g}^{′}}_{ij} = \{ {\sum }_{k = 1}^{m} {a}_{ik} {g}_{kj} \}$$

for i=1, 2, . . . , m, and j=1, 2, . . . , n, where {z} stands for the fractional part of the real number z (for example, {1.7}=0.7, {−1.7}=0.3).

FIG. 5 represents a basic procedure of implementing the routine of FIG. 3 in the case when the monoid operation consists of taking the fractional part of sum of real numbers.

In the block 501 a real m×n matrix g=(gᵢⱼ) is generated.

Independently, in the block 502 an integer n×n matrix B is generated.

And, in the block 503 the fractional product {g·B} is computed according to the formula:

$$\{ g \cdot B \} = ( {{g}^{″}}_{ij} ) , \\ where$$

$${{g}^{″}}_{ij} = \{ {\sum }_{l = 1}^{n} {g}_{il} {b}_{lj} \}$$

for i=1, 2, . . . , m, and j=1, 2, . . . , n;

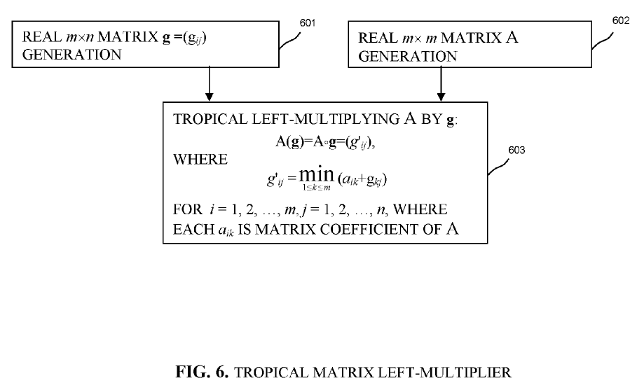

FIG. 6 represents a basic procedure of implementing the routine of FIG. 2 in the case when the monoid operation is tropical, i.e., it consists of taking the minimum two real numbers.

In the block 601 a real m×n matrix g=(gᵢⱼ) is generated.

Independently, in the block 602 a real m×m matrix A is generated.

And, in the block 603 the tropical product A∘g is computed according to the formula:

$$A ∘ g = ( {{g}^{′}}_{ij} ) , \\ where$$

$${{g}^{′}}_{ij} = {min}_{1 \leq k \leq m} ( {a}_{ik} + {g}_{kj} )$$

for i=1, 2, . . . , m, and j=1, 2, . . . , n.

FIG. 7 represents a basic procedure of implementing the routine of FIG. 2 in the case when the monoid operation is tropical, i.e., it consists of taking the minimum two real numbers.

In the block 701 a real m×n matrix g=(gᵢⱼ) is generated.

Independently, in the block 702 a real n×n matrix B is generated.

And, in the block 703 the tropical product g∘B is computed according to the formula:

$$g ∘ B = ( {{g}^{″}}_{ij} ) , \\ where$$

$${{g}^{″}}_{ij} = {min}_{1 \leq l \leq n} ( {g}_{il} + {b}_{lj} )$$

for i=1, 2, . . . , m, and j=1, 2, . . . , n.

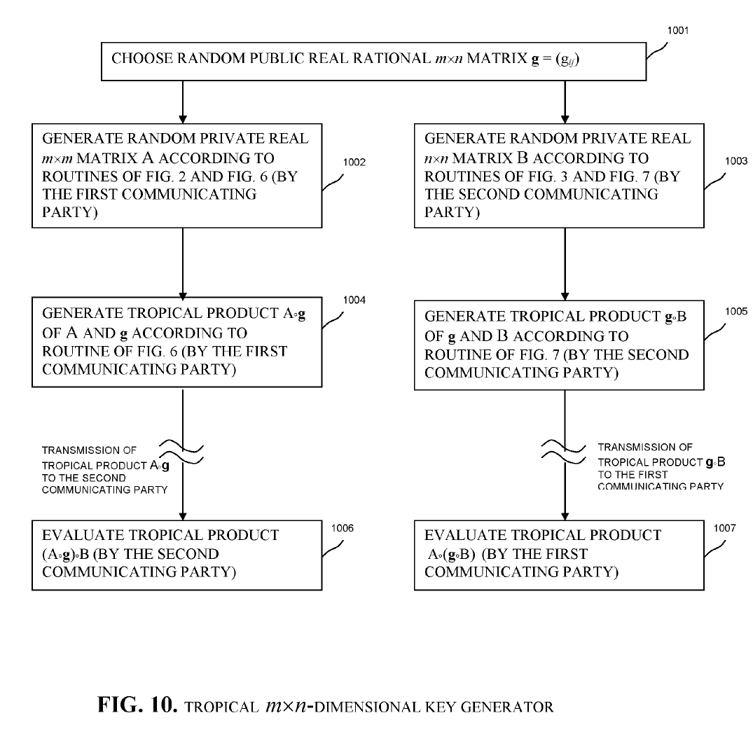

FIG. 8 illustrates creation, establishment, and distribution of an algebro-geometric key in the preferred embodiment of the system of the present invention. It refers to the routines illustrated by other referenced flow diagrams (FIG. 1, FIG. 2, FIG. 3, FIG. 4, FIG. 5, FIG. 6, FIG. 7) which describe features in accordance with an embodiment of the invention.

The block 801 represents choosing at random a public m×n matrix g=(gᵢⱼ), which coefficients belong to the public commutative topological monoid X. This g is to be used by both communicating parties.

The block 802 represents the routine that can be used by the first communicating party for generating a private matrix A according to the routine of FIG. 2.

Similarly, the block 803 represents the routine that can be used by the second communicating party for generating a private matrix B according to the routine of FIG. 3.

The block 804 represents computation (by the first communicating party) of the m×n matrix A(g) according to the routine of FIG. 2, and rounding (if necessary) the matrix A(g) to the nearest m×n matrix [A(g)]. The rounded m×n matrix [A(g)] is then transmitted over an open (public) channel to the second communicating party.

Similarly, the block 805 represents computation (by the second communicating party) of the m×n matrix (g)B according to the routine of FIG. 3, and rounding (if necessary) the matrix (g)B to the nearest m×n matrix [(g)B]. The rounded m×n matrix [(g)B] is then transmitted over an open (public) channel to the first communicating party.

The block 806 represents the routine that can be used by the second communicating party for generating the m×n matrix ([A(g)])B (according to the routine of FIG. 2) and rounding it to the nearest m×n matrix [([A(g)])B].

Similarly, the block 807 represents the routine that can be used by the first communicating party for generating the m×n matrix A([(g)B]) (according to the routine of FIG. 3) and rounding it to the nearest m×n matrix [A[(g)B]].

By the design, the m×n matrices [([A(g)])B] and [A([(g)B])] are equal, and thus comprise the common secret algebro-geometric key in possession of both communicating parties.

FIG. 9 represents creation, establishment, and distribution of a key in the fractional embodiment of the algebro-geometric key establishment system of present invention.

First, public natural numbers d, N, K are generated in the block 901. Next, a public real m×n matrix g=(gᵢⱼ) is generated in such a way that each gᵢⱼ is a fractional decimal number having d+2N+K+┌log₁₀(mn)┐ digits after dot (where ┌z┐ denotes rounding of a real number z to the smallest integer greater than z) is generated in the same block 901.

Then in the block 902, a private integer matrix A is generated according to routines of FIG. 2 and FIG. 4 (in this case the semi-ring A is the ring of all integers).

In a similar manner, in the block 903 a private integer matrix B is generated according to routines of FIG. 3 and FIG. 5 (in this case the semi-ring A is the ring of all integers).

In the block 904 the fractional m×n matrix {A·g} is computed according to the routine of FIG. 4. Next, each coefficient of the m×n matrix {A·g} is rounded to d+N+K+┌log₁₀(mn)┐ decimal places. The rounded fractional m×n matrix {A·g} is then transmitted to the second communicating party.

In a similar manner, in the block 905 the fractional m×n matrix {g·B} is computed according to the routine of FIG. 5. Next, each coefficient of the m×n matrix {g·B} is rounded to d+N+K+┌log₁₀(mn)┐ decimal places. The rounded fractional m×n matrix {g·B} is then transmitted to the second communicating party.

The block 906 represents the routine that can be used by the second communicating party for computing the fractional m×n matrix {{A·g}·B}. The loop 908 is used in the case when the m×n matrix {{A·g}·B} is not (K, d)-consistent (that is, in the case when the sequence of the digits a_{K+1}, a_{K+2}, . . . a_{K+d} of at least one coordinate of the m×n matrix {{A·g}·B} is either 0, 0, . . . , 0 or 9, 9, . . . , 9.) The loop 708 is continued until the m×n matrix {{A·g}·B} becomes (K, d)-consistent. [The probability of a m×n matrix {{A·g}·B} to be not (K, d)-consistent is extremely low. Namely, this probability is measured as at most 1−(1−2·10^{-d})^{mn}. The probability of the need for the second run of the loop 908 is measured as at most (1−(1−2·10^{-d})^{mn})²]. The block 910 is then entered, this block represents the generation of a m×n matrix S which is the rounding of the (K, d)-consistent m×n matrix {{A·g}·B} to K decimal places.

In a similar manner the block 907 represents the routine that can be used by the first communicating party for computing the fractional m×n matrix {A·{g·B}}. The loop 909 is used in the case when the m×n matrix {A·{g·B}} is not (K, d)-consistent (that is, in the case when the sequence of the digits a_{K+1}, a_{K+2}, . . . a_{K+d} of at least one coordinate of the m×n matrix {A·{g·B}} is either 0, 0, . . . , 0 or 9, 9, . . . , 9.) The loop 709 is continued until the m×n matrix {A·{g·B}} becomes (K, d)-consistent. [The probability of a m×n matrix {A·{g·B}} to be not (K, d)-consistent is extremely low. Namely, this probability is measured as at most 1−(1−2·10^{-d})^{mn}. The probability of the need for the second run of the loop 709 is measured as at most (1−(1−2·10^{-d})^{mn})²]. The block 911 is then entered, this block represents the generation of an m×n matrix S′ which is the rounding of the (K, d)-consistent m×n matrix {A·{g·B}} to K decimal places.

By the design, the m×n matrices S and S′ are equal, and thus comprise the common secret key in possession of both communicating parties.

FIG. 10 represents creation, establishment, and distribution of a key in a tropical embodiment of the algebro-geometric key establishment system of present invention.

First, in the block 1001 a public real m×n matrix g=(gᵢⱼ) is generated.

Then in the block 1002, a private real m×m matrix A is generated according to routines of FIG. 2 and FIG. 6 (in this case A is the semi-ring of all real numbers and the ideal element +∞ with the tropical addition and multiplication: x⊕y=min(x, y), x∘y=x+y).

In a similar manner, in the block 1003 a private real n×n matrix B is generated according to routines of FIG. 3 and FIG. 7 (in this case A is also the semi-ring of all real numbers and +∞ with the tropical addition and multiplication).

In the block 1004 the tropical product A∘g of matrices A and g is computed according to the routine of FIG. 6.

The real m×n matrix A∘g is then transmitted to the second communicating party.

In a similar manner, in the block 1005 the tropical product g∘B of matrices g and B is computed according to the routine of FIG. 7.

The real m×n matrix g∘B is then transmitted to the second communicating party.

The block 1006 represents the routine that can be used by the second communicating party for computing the real m×n matrix (A∘g)∘B.

In a similar manner the block 1007 represents the routine that can be used by the first communicating party for computing the real m×n matrix A∘(g∘B).

By the design, the m×n matrices (A∘g)∘B and A∘(g∘B) are equal, and thus comprise the common secret key in possession of both communicating parties.

The system of present invention is a continuous generalization of the Diffie-Hellman paradigm. Therefore, the security of the system hereof is based on the correlation of the continuous and discrete aspects of the systems internal (secret) and external (public) components.

In particular, the security of the fractional embodiment of the system hereof comes from the built-in geometric density of certain sequences of irrational numbers in the semi-open interval [0, 1) of the real line. In other words, security is guaranteed by the obvious mathematical fact that there is no any a priori known general distribution pattern for members of certain sequences of irrational numbers. More precisely, let β₁, β₂, . . . be a sequence of irrational numbers (or more generally, of irrational elements of a compact Lie group) and let γ be an irrational number computed with the precision of K decimal places. Then any algorithm that recognizes γ as an element of the sequence β₁, β₂, . . . and identifies the index n such that γ=βₙ must work at least C·10^{K} units of time where C is an a priori given constant.

The security of the tropical embodiment of the system hereof comes from the difficulty of the task of reconstructing, based on the known algebraic structure of a multitude of real numbers, the real numbers comprising the multitude. More precisely, in the n×n tropical embodiment the multitude of choices is estimated as nⁿ^{²}. In particular, if n=10, the number of choices a cryptanalyst will face is about 10¹⁰⁰.

Apparently, approaches that are the closest to the present invention are developed in U.S. Pat. No. 5,696,826 entitled METHOD AND APPARATUS FOR ENCRYPTING AND DECRYPTING INFORMATION USING A DIGITAL CHAOS SIGNAL by Gao, in U.S. Pat. No. 6,493,449 entitled METHOD AND APPARATUS FOR CRYPTOGRAPHICALLY SECURE ALGEBRAIC KEY ESTABLISHMENT PROTOCOLS BASED ON MONOIDS by Anshel et al, and in U.S. patent application Ser. No. 10/605,935 entitled GEOMETRY-BASED SYMMETRIC CRYPTOSYSTEM METHOD by Berenstein and Chernyak, and in U.S. patent application Ser. No. 10/708,197 entitled METHOD AND APPARATUS FOR GEOMETRIC KEY ESTABLISHMENT PROTOCOLS BASED ON TOPOLOGICAL GROUPS by the authors Berenstein and Chernyak.

The idea of using fractional parts of multiples of given irrational numbers is not new in cryptography. These fractional parts were used, for example, in the patent by Gao for obtaining uniform distributions of numbers in the unit interval. However, this is perhaps the only similarity between those previous works and the system of the present invention. In the system hereof, fractional parts of multiples of given irrational numbers are never used for obtaining a uniform distribution of numbers, but rather for creation of a deterministic (non-random) keys.

The idea of using infinite groups and semigroups for key establishment and distribution is relatively new. It is presented in U.S. Pat. No. 6,493,449 by Anshel et al. However, the present invention is the first where continuous groups and monoids are used for key establishment and distribution. In U.S. patent application Ser. No. 10/605,935 by Berenstein and Chernyak the geometric continuity is utilized for constructing private encryption systems.

The present invention combines the idea of Diffie-Hellman protocol of key establishment with the idea of the geometric cryptosystem developed in U.S. patent application Ser. No. 10/605,935 by the authors Arkady Berenstein and Leon Chernyak and the idea of the geometric cryptosystem developed in the U.S. patent application Ser. No. 10/708,197 by the authors Arkady Berenstein and Leon Chernyak.

An embodiment of the system hereof (to be referred as a fractional 2×2-dimensional embodiment) deals with a publicly chosen real 2×2 matrix g and a pair of secret integer 2×2 matrices A and B, where the matrix A is generated by the first communicating party and the matrix B—by the second communicating party. Absolute values matrix coefficients of these matrices are bounded by a publicly available constant 10^{N} that may be arbitrarily big. Thus the keys created and distributed by the system hereof can be of any given in advance size.

A fractional 2×2-dimensional embodiment of the system hereof works with a 2×2 matrix g of the form

$$g = [ \begin{matrix}{g}_{11} & {g}_{12} \\ {g}_{21} & {g}_{22}\end{matrix} ]$$

where g₁₁, g₁₂, g₂₁, g₂₂ are real numbers; and with 2×2 matrices A and B of the form:

$$A = [ \begin{matrix}{a}_{11} & {a}_{12} \\ {a}_{21} & {a}_{22}\end{matrix} ]$$

where a₁₁, a₁₂, a₂₁, a₂₂ are non-negative integers; and

$$B = [ \begin{matrix}{b}_{11} & {b}_{12} \\ {b}_{21} & {b}_{22}\end{matrix} ]$$

and where b₁₁, b₁₂, b₂₁, b₂₂ are non-negative integers.

Absolute values of each integer a₁₁, a₁₂, a₂₁, a₂₂, b₁₁, b₁₂, b₂₁, b₂₂ are bounded by a publicly available constant 10^{N} that may be arbitrarily big. Thus the keys created and distributed by the system hereof can be of any given in advance size.

In this embodiment the 2×2 matrix g has coefficients g₁₁, g₁₂, g₂₁, g₂₂ which are arbitrary real numbers, that is, g is an arbitrary point of the 4-dimensional space.

Let {x} be the fractional part of a real number x. By definition, for each real number x, the fractional part {x} is given by:
{x}=x−[x],
where [x] is the integer part of x, that is, [x] is the greatest integer that is less or equal x.

If the numbers a₀, a₁ and b₀, b₁ are integers having at most N decimal digits each (that is, |a₁₁|<10^{N}, |a₁₂|<10^{N}, |a₂₁|<10^{N}, |a₂₂|<10^{N} and |b₁₁|<10^{N}, |b₁₂|<10^{N}, |b₂₁|<10^{N}, |b₂₂|<10^{N}) and each coordinate of the following 2×2 matrices

$$\{ A \cdot g \} = [ \begin{matrix}\{ {a}_{11} {g}_{11} + {a}_{12} {g}_{21} \} & \{ {a}_{11} {g}_{12} + {a}_{12} {g}_{22} \} \\ \{ {a}_{21} {g}_{11} + {a}_{22} {g}_{21} \} & \{ {a}_{21} {g}_{12} + {a}_{22} {g}_{22} \}\end{matrix} ]$$

$$and$$

$$\{ g \cdot B \} = [ \begin{matrix}\{ {g}_{11} {b}_{11} + {g}_{12} {b}_{21} \} & \{ {g}_{11} {b}_{12} + {g}_{12} {b}_{22} \} \\ \{ {g}_{21} {b}_{11} + {g}_{22} {b}_{21} \} & \{ {g}_{21} {b}_{12} + {g}_{22} {b}_{22} \}\end{matrix} ]$$

is rounded to d+N+K+1 decimal places after dot (where d, N, and K are natural numbers each greater than 1), then the created and distributed key, which is the 2×2 matrix {A·g·B}, in each of its coordinates will have K correct decimal places after the dot. These 2K correct digits can serve as an encryption/decryption key of a cryptosystem.

The security of this two-dimensional embodiment is further enhanced even in comparison with the high security of the one-dimensional embodiment.

In creating algebro-geometric key establishment system in accordance with the 2-dimensional embodiment hereof, a first step is to choose publicly available parameters of the system: a real 2×2 matrix g and natural numbers d, N, K, each greater than 1, where d stands for the size of the error control buffer, N stands for the maximum number of decimal places in each secret parameter a and b, and K stands for the key length.

This embodiment of the algebro-geometric key establishment system hereof relies on the concept of (K, d)-consistent matrices. An infinite decimal fraction δ=0. a₁, a₂ a₃ . . . is said to be (K, d)-consistent if the sequence of the digits a_{K+1}, a_{K+2}, . . . , a_{K+d} is neither 0, 0, . . . , 0 nor 9, 9, . . . , 9. We say that a matrix g is (K, d)-consistent both x₁ and x₂ are (K, d)-consistent numbers.

To implement the key creation and key distribution of this example, the first communicating party, call it Alice, chooses a secret integer 2×2 matrix A each coefficient of which is between −10^{N} and 10^{N} (i.e., each of these four coefficients has at most N decimal places). Then Alice calculates the 2×2 matrix y={A·g} by the formula:

$$y = \{ A \cdot g \} = [ \begin{matrix}\{ {a}_{11} {g}_{11} + {a}_{12} {g}_{21} \} & \{ {a}_{11} {g}_{12} + {a}_{12} {g}_{22} \} \\ \{ {a}_{21} {g}_{11} + {a}_{22} {g}_{21} \} & \{ {a}_{21} {g}_{12} + {a}_{22} {g}_{22} \}\end{matrix} ]$$

and then rounds each coefficient of y to d+N+K+1 decimal places; and sends so rounded matrix [y] to the second communicating party, call it Bob. [It is assumed in this example that Alice and Bob share the publicly available parameters g and d, N, K.]

Simultaneously and independently Bob chooses a secret integer 2×2 matrix A each coefficient of which is between −10^{N} and 10^{N} (i.e., each of these four coefficients has at most N decimal places). Then Bob calculates the 2×2 matrix z={g·B} by the formula:

$$z = \{ g \cdot B \} = [ \begin{matrix}\{ {g}_{11} {b}_{11} + {g}_{12} {b}_{21} \} & \{ {g}_{11} {b}_{12} + {g}_{12} {b}_{22} \} \\ \{ {g}_{21} {b}_{11} + {g}_{22} {b}_{21} \} & \{ {g}_{21} {b}_{12} + {g}_{22} {b}_{22} \}\end{matrix} ]$$

and then rounds each coefficient of z rounded to d+N+K decimal places; and sends so rounded matrix [z] to Alice.

Upon receiving the 2×2 matrix [y] from Alice, Bob calculates the matrix k={[y]·B} by the formula:

$$k = [ \begin{matrix}\begin{matrix}\{ ( {a}_{11} {g}_{11} + {a}_{12} {g}_{21} ) {b}_{11} + \\ ( {a}_{11} {g}_{12} + {a}_{12} {g}_{22} ) {b}_{21} \}\end{matrix} & \begin{matrix}\{ ( {a}_{11} {g}_{11} + {a}_{12} {g}_{21} ) {b}_{12} + \\ ( {a}_{11} {g}_{12} + {a}_{12} {g}_{22} ) {b}_{22} \}\end{matrix} \\ \begin{matrix}\{ ( {a}_{21} {g}_{11} + {a}_{22} {g}_{21} ) {b}_{11} + \\ ( {a}_{21} {g}_{12} + {a}_{22} {g}_{22} ) {b}_{21} \}\end{matrix} & \begin{matrix}\{ ( {a}_{21} {g}_{11} + {a}_{22} {g}_{21} ) {b}_{12} + \\ ( {a}_{21} {g}_{12} + {a}_{22} {g}_{22} ) {b}_{22} \}\end{matrix}\end{matrix} ]$$

If the matrix k is (K, d)-consistent then Bob calculates the algebro-geometric key S by rounding each matrix coefficient of k to K decimal places. Otherwise, he restarts the protocol.

Upon receiving the 2×2 matrix [z] from Bob, Alice calculates the 2×2 matrix k′={A·[z]} by the formula:

$${k}^{′} = [ \begin{matrix}\begin{matrix}\{ {a}_{11} ( {g}_{11} {b}_{11} + {g}_{12} {b}_{21} ) + \\ {a}_{12} ( {g}_{21} {b}_{11} + {g}_{22} {b}_{21} ) \}\end{matrix} & \begin{matrix}\{ {a}_{11} ( {g}_{11} {b}_{12} + {g}_{12} {b}_{22} ) + \\ {a}_{12} ( {g}_{21} {b}_{12} + {g}_{22} {b}_{22} ) \}\end{matrix} \\ \begin{matrix}\{ {a}_{21} ( {g}_{11} {b}_{11} + {g}_{12} {b}_{21} ) + \\ {a}_{22} ( {g}_{21} {b}_{11} + {g}_{22} {b}_{21} ) \}\end{matrix} & \begin{matrix}\{ {a}_{11} ( {g}_{11} {b}_{12} + {g}_{12} {b}_{22} ) {a}_{21} + \\ {a}_{22} ( {g}_{21} {b}_{12} + {g}_{22} {b}_{22} ) \}\end{matrix}\end{matrix} ]$$

If the matrix k′ is (K, d)-consistent then Alice calculates the algebro-geometric key S′ by rounding each coefficient of k′ to K decimal places. Otherwise, she restarts the protocol.

The mathematical argument presented below proves that the algebro-geometric key S in possession of Bob equals the algebro-geometric key S′ in possession of Alice.

In those (extremely rare) cases when k is not (K, d)-consistent, the algebro-geometric key has to be redistributed because otherwise it may happen that S≠S′. In order to avoid such a situation, Alice and Bob choose new secret integer 2×2 matrix A′ and B′ respectively (while keeping the same g and d, N, K) and repeat the above steps until they get a new algebro-geometric key S=S′ (provided that the new matrix k is (K, d)-consistent). The probability of the need for such redistribution is extremely low and is measured as at most 1−(1−2·10^{-d})⁴ The probability of the need for the second key distribution is measured as at most (1−(1−2·10^{-d})⁴)².

The embodiment of the system hereof is based on the following mathematical argument.

Proposition. Let be P=(Pᵢⱼ), Q=(Qᵢⱼ), and L=(Lᵢⱼ) be m×n matrices of natural numbers. Let α=(αᵢₖ) be an arbitrary m×m matrix with natural coefficients and let β=(βₗⱼ) be an arbitrary n×n matrix with natural coefficients such that:
α·Q*≦L*, P*·β≦L*,
where P*=(1/Pᵢⱼ), Q*=(1/Qᵢⱼ), L*=(1/(Lᵢⱼ)), and the m×n matrix inequality Y≦Z is equivalent to m·n scalar inequalities: yᵢⱼ≦zᵢⱼ. Then for any integer m×m matrix A, any integer m×n matrix B satisfying |aᵢₖ|<αᵢₖ, |bₗⱼ|<βₗⱼ (i, k=1, 2, . . . , m, j, l=1, 2, . . . , n) one has:
either at least one matrix coefficient of [{([{A·g}]_{P})·B}]_{L} equals 0, or at least one matrix coefficient of [{([{g·B}]_{Q})·A}]_{L} equals 0, or
   −L*<{([{A·g}]_{P})·B}−{(A·[{g·B}]_{Q})}<L*.

Proof: By definition, one has:
[{A·g}]_{P}={A·g}+θ₁, [{g·B}]_{Q}={g·B}+θ₂,
where θ₁ and θ₂ are m×n matrices such that −½P*≦θ₁≦½P* and −½Q*≦θ₂≦½Q*. Therefore,
([{A·g}]_{P})·B=({A·g}+θ₁)·B={A·g}·B+θ₁·B={A·g}·B+E₁,
where E₁=θ₁·B. Similarly,
A·([{g·B}]_{Q})=A·({g·B}+θ₂·Q⁻¹)=A·{g·B}+A·θ₂=A·{g·B}+E₂,
where E₂=A·θ₂.

By the assumptions, one has:
|E₁|=|θ₁·B|≦½·|P*·B|<½·P*·β≦½·L*, |E₂|=|A·θ₂|≦½·|A·Q*|<½·Q*·α≦½·L*.
In its turn, this implies that either at least one matrix coefficient in |([{A·g}]_{P})·B| is not greater than the corresponding coefficient of L*/2 or |([{A·g}]_{P})·B|>L*/2 and:
{([{A·g}]_{P})·B}={{A·g}·B+E₁}={{A·g}·B}+E₁={A·g·B}+E₁.
Similarly, the above implies that either at least one matrix coefficient in |A·([{g·B}]_{Q})| is not greater than the corresponding coefficient of L*/2 or |A·([{g·B}]_{Q})|>L*/2 and:
{A·([{g·B}]_{Q})}={A·{g·B}+E₂}={A·{g·B}}+E₂={A·g·B}+E₂.
Therefore {([{A·g}]_{P})·B}−{A·([{g·B}]_{Q})}=E₁−E₂.

Finally note that −L*=−L*/2−L*/2<E₁−E₂<L*/2+L*/2=L*.

This finishes the proof.

A real m×n matrix x=(xᵢⱼ) is said to be (K, d)-consistent if:
−c·1ₘₙ≦x−[x]_{K}≦c·1ₘₙ,
where c=½−1/(2d) and 1ₘₙ is the m×n matrix in which all matrix coefficients are equal 1.

Corollary. In the notation of Proposition, if L=d·K and one the m×n matrices {([{A·g}]_{P})·B}, {A·([{g·B}]_{Q})} is (K, d)-consistent then [([{A·g}]_{P})·B]_{K}=[A·([{g·B}]_{Q})]_{K}.

For the 2×2-dimensional embodiment of the system hereof the Corollary is applied with m=n=2, K₁₁=K₁₂=K₂₁=K₂₂=K. Therefore, the Corollary guarantees that S=S′ in the protocol.

In creating an algebro-geometric key establishment system in accordance with the 2×2-dimensional embodiment hereof (and with the following small numbers for ease of illustration), a first step is to choose publicly available parameters of the system: a 2×2 matrix g and integer parameters d, N, K greater than 1 each.

Take, for example,

$$g = [ \begin{matrix}√ 2 & √ 3 \\ √ 5 & √ 7\end{matrix} ]$$

and N=K=3, d=2.

Next, suppose that Alice chooses a secret integer 2×2 matrix A:

$$A = [ \begin{matrix}123 & 456 \\ 817 & 391\end{matrix} ]$$

Alice calculates the 2×2 matrix y=[{A·g}] each element of which rounded to d+N+K+1=9 decimal places:

$$y = [ \{ A \cdot g \} ] = [ \begin{matrix}0.595265912 & 0.504847176 \\ 0.715059661 & 0.574272410\end{matrix} ]$$

and sends this 2×2 matrix y to Bob.

Suppose that at the same time Bob chooses a secret integer 2×2 matrix B:

$$B = [ \begin{matrix}691 & 378 \\ 529 & 109\end{matrix} ]$$

Bob calculates the 2×2 matrix z=[{g·B}] each element of which rounded to d+N+K+1=9 decimal places:

$$z = [ \{ g \cdot B \} ] = [ \begin{matrix}0.476448804 & 0.366264602 \\ 0.725416006 & 0.620588401\end{matrix} ]$$

and sends this 2×2 matrix z to Alice.

Upon receiving the 2×2 matrix y from Alice, Bob calculates the 2×2 matrix k=[{y·B}] with the precision K+d=5 decimal places after dot:

$$k = [ \{ y \cdot B \} ] = [ \begin{matrix}0.39290 & 0.03885 \\ 0.89633 & 0.88824\end{matrix} ]$$

Since this 2×2 matrix is (K, d)-consistent, the 2×2 matrix k, after having been rounded to the first K=3 digits of each element, constitutes the algebro-geometric key in possession of Bob:

$$S = [ \begin{matrix}0.393 & 0.039 \\ 0.897 & 0.889\end{matrix} ]$$

Upon receiving the 2×2 matrix z from Bob, Alice calculates the 2×2 matrix k′=[{A·[z]}] with the precision K+d=5 decimal places after dot:

$${k}^{′} = [ \{ A \cdot z \} ] = [ \begin{matrix}0.39290 & 0.03885 \\ 0.89633 & 0.88824\end{matrix} ]$$

Since this each element of this 2×2 matrix is (K, d)-consistent the 2×2 matrix k′, after having been rounded to the first K=3 digits of each element, constitutes the algebro-geometric key in possession of Alice:

$${S}^{′} = [ \begin{matrix}0.393 & 0.039 \\ 0.897 & 0.889\end{matrix} ]$$

Thus, the 2×2 matrix S=S′ is the algebro-geometric key shared by Alice and Bob. This key can be used in any major symmetric cryptosystem.

Another embodiment of the system hereof (to be referred as a tropical 2×2-dimensional embodiment) deals with a publicly chosen real 2×2 matrix g and a pair of secret real 2×2 matrices A and B, where the matrix A is generated by the first communicating party and the matrix B—by the second communicating party. The matrix coefficients of these matrices and the keys created and distributed by the system hereof can be of any given in advance size.

A tropical 2×2-dimensional embodiment of the system hereof works with a 2×2 matrix g of the form

$$g = [ \begin{matrix}{g}_{11} & {g}_{12} \\ {g}_{21} & {g}_{22}\end{matrix} ]$$

where g₁₁, g₁₂, g₂₁, g₂₂ are real numbers; and with 2×2 matrices A and B of the form:

$$A = [ \begin{matrix}{a}_{11} & {a}_{12} \\ {a}_{21} & {a}_{22}\end{matrix} ] \qquad B = [ \begin{matrix}{b}_{11} & {b}_{12} \\ {b}_{21} & {b}_{22}\end{matrix} ]$$

where a₁₁, a₁₂, a₂₁, a₂₂ are real numbers; and b₁₁, b₁₂, b₂₁, b₂₂ are real numbers.

To implement the key creation and key distribution of this embodiment, the first communicating party, call it Alice calculates the 2×2 matrix y={A·g} by the formula:

$$y = A ∘ g = [ \begin{matrix}min ( {a}_{11} + {g}_{11} , {a}_{12} + {g}_{21} ) & min ( {a}_{11} + {g}_{12} , {a}_{12} + {g}_{22} ) \\ min ( {a}_{21} + {g}_{11} , {a}_{22} + {g}_{21} ) & min ( {a}_{21} + {g}_{12} , {a}_{22} + {g}_{22} )\end{matrix} ]$$

and sends y to the second communicating party, call it Bob. [It is assumed that Alice and Bob share the publicly available parameter g].

Simultaneously and independently Bob calculates the 2×2 matrix z=g∘B by the formula:

$$z = g ∘ B = [ \begin{matrix}min ( {g}_{11} + {b}_{11} , {g}_{12} + {b}_{21} ) & min ( {g}_{11} + {b}_{12} , {g}_{12} + {b}_{22} ) \\ min ( {g}_{21} + {b}_{11} , {g}_{22} + {b}_{21} ) & min ( {g}_{21} + {b}_{12} , {g}_{22} + {b}_{22} )\end{matrix} ]$$

and sends z to Alice.

Upon receiving the 2×2 matrix y from Alice, Bob calculates the matrix k=y∘B by the formula:

$$S = y ∘ B = [ \begin{matrix}min ( {y}_{11} + {b}_{11} , {y}_{12} + {b}_{21} ) & min ( {y}_{11} + {b}_{12} , {y}_{12} + {b}_{22} ) \\ min ( {y}_{21} + {b}_{11} , {y}_{22} + {b}_{21} ) & min ( {y}_{21} + {b}_{12} , {y}_{22} + {b}_{22} )\end{matrix} ]$$

Upon receiving the 2×2 matrix z from Bob, Alice calculates the 2×2 matrix k′=A∘z by the formula:

$${S}^{′} = A ∘ z = [ \begin{matrix}min ( {a}_{11} + {z}_{11} , {a}_{12} + {z}_{21} ) & min ( {a}_{11} + {z}_{12} , {a}_{12} + {z}_{22} ) \\ min ( {a}_{21} + {z}_{11} , {a}_{22} + {z}_{21} ) & min ( {a}_{21} + {z}_{12} , {a}_{22} + {z}_{22} )\end{matrix} ]$$

A direct computation shows that

$$S = {S}^{′} = [ \begin{matrix}\begin{matrix}min ( {a}_{11} + {g}_{11} + {b}_{11} , \\ {a}_{11} + {g}_{12} + {b}_{21} , \\ {a}_{12} + {g}_{21} + {b}_{11} , \\ {a}_{12} + {g}_{22} + {b}_{21} )\end{matrix} & \begin{matrix}min ( {a}_{11} + {g}_{11} + {b}_{12} , \\ {a}_{11} + {g}_{12} + {b}_{22} , \\ {a}_{12} + {g}_{21} + {b}_{12} , \\ {a}_{12} + {g}_{22} + {b}_{22} )\end{matrix} \\ \begin{matrix}min ( {a}_{21} + {g}_{11} + {b}_{11} , \\ {a}_{21} + {g}_{12} + {b}_{21} , \\ {a}_{22} + {g}_{21} + {b}_{11} , \\ {a}_{22} + {g}_{22} + {b}_{21} )\end{matrix} & \begin{matrix}min ( {a}_{21} + {g}_{11} + {b}_{12} , \\ {a}_{21} + {g}_{12} + {b}_{22} , \\ {a}_{22} + {g}_{21} + {b}_{12} , \\ {a}_{22} + {g}_{22} + {b}_{22} )\end{matrix}\end{matrix} ]$$

Thus, the algebro-geometric key S in possession of Bob equals the algebro-geometric key S′ in possession of Alice.

In creating an algebro-geometric key establishment system in accordance with the tropical 2×2-dimensional embodiment hereof (and with the following small numbers for ease of illustration), a first step is to choose publicly available parameters of the system: a 2×2 matrix g.

Take, for example,

$$g = [ \begin{matrix}√ 2 & √ 3 \\ √ 5 & √ 7\end{matrix} ]$$

Next, suppose that Alice chooses a secret real 2×2 matrix A:

$$A = [ \begin{matrix}√ 123 & √ 456 \\ √ 817 & √ 391\end{matrix} ]$$

Alice calculates the 2×2 matrix y=A·g:

$$\begin{matrix}y = A ∘ g \\ = [ \begin{matrix}\begin{matrix}min ( √ 123 + √ 2 , \\ √ 456 + √ 5 )\end{matrix} & \begin{matrix}min ( √ 123 + √ 3 , \\ √ 456 + √ 7 )\end{matrix} \\ \begin{matrix}min ( √ 817 + √ 2 , \\ √ 391 + √ 5 )\end{matrix} & \begin{matrix}min ( √ 817 + √ 3 , \\ √ 391 + √ 7 )\end{matrix}\end{matrix} ] \\ = [ \begin{matrix}√ 123 + √ 2 & √ 123 + √ 3 \\ √ 391 + √ 5 & √ 391 + √ 7\end{matrix} ]\end{matrix}$$

and sends this 2×2 matrix y to Bob.

Suppose that at the same time Bob chooses a secret integer 2×2 matrix B:

$$B = [ \begin{matrix}√ 691 & √ 378 \\ √ 529 & √ 109\end{matrix} ]$$

Bob calculates the 2×2 matrix z=g∘B:

$$\begin{matrix}z = g ∘ B \\ = [ \begin{matrix}\begin{matrix}min ( √ 2 + √ 691 , \\ √ 3 + √ 529 )\end{matrix} & \begin{matrix}min ( √ 2 + √ 378 , \\ √ 3 + √ 109 )\end{matrix} \\ \begin{matrix}min ( √ 5 + √ 691 , \\ √ 7 + √ 529 )\end{matrix} & \begin{matrix}min ( √ 5 + √ 378 , \\ √ 7 + √ 109 )\end{matrix}\end{matrix} ] \\ = [ \begin{matrix}√ 3 + √ 529 & √ 3 + √ 109 \\ √ 7 + √ 529 & √ 7 + √ 109\end{matrix} ]\end{matrix}$$

and sends this 2×2 matrix z to Alice.

Upon receiving the 2×2 matrix y from Alice, Bob calculates the 2×2 matrix S=y∘B:

$$\begin{matrix}S = y ∘ B \\ = [ \begin{matrix}\begin{matrix}min ( √ 123 + √ 2 + √ 691 , \\ √ 123 + √ 3 + √ 529 )\end{matrix} & \begin{matrix}min ( √ 123 + √ 2 + √ 378 , \\ √ 123 + √ 3 + √ 109 )\end{matrix} \\ \begin{matrix}min ( √ 391 + √ 5 + √ 691 , \\ √ 391 + √ 7 + √ 529 )\end{matrix} & \begin{matrix}min ( √ 391 + √ 5 + √ 378 , \\ √ 391 + √ 7 + √ 109 )\end{matrix}\end{matrix} ] \\ = [ \begin{matrix}√ 123 + √ 3 + √ 529 & √ 123 + √ 3 + √ 109 \\ √ 391 + √ 7 + √ 529 & √ 391 + √ 7 + √ 109\end{matrix} ]\end{matrix}$$

The 2×2 matrix S constitutes the algebro-geometric key in possession of Bob:

$$S = [ \begin{matrix}√ 123 + √ 3 + √ 529 & √ 123 + √ 3 + √ 109 \\ √ 391 + √ 7 + √ 529 & √ 391 + √ 7 + √ 109\end{matrix} ]$$

Upon receiving the 2×2 matrix z from Bob, Alice calculates the 2×2 matrix S′=A∘z:

$$\begin{matrix}{S}^{′} = A ∘ z \\ = [ \begin{matrix}\begin{matrix}min ( √ 123 + √ 3 + √ 529 , \\ √ 456 + √ 7 + √ 529 )\end{matrix} & \begin{matrix}min ( √ 123 + √ 3 + √ 109 , \\ √ 456 + √ 7 + √ 109 )\end{matrix} \\ \begin{matrix}min ( √ 817 + √ 3 + √ 529 , \\ √ 391 + √ 7 + √ 529 )\end{matrix} & \begin{matrix}min ( √ 817 + √ 3 + √ 109 , \\ √ 391 + √ 7 + √ 109 )\end{matrix}\end{matrix} ] \\ = [ \begin{matrix}√ 123 + √ 3 + √ 529 & √ 123 + √ 3 + √ 109 \\ √ 391 + √ 7 + √ 529 & √ 391 + √ 7 + √ 109\end{matrix} ]\end{matrix}$$

The 2×2 matrix S′ constitutes the algebro-geometric key in possession of Alice:

$${S}^{′} = [ \begin{matrix}√ 123 + √ 3 + √ 529 & √ 123 + √ 3 + √ 109 \\ √ 391 + √ 7 + √ 529 & √ 391 + √ 7 + √ 109\end{matrix} ]$$

Thus, the 2×2 matrix S=S′ constitutes the algebro-geometric key shared by Alice and Bob. This key can be used in any major symmetric cryptosystem.

The invention has been described with reference to a particular preferred embodiment, but variations within the spirit and scope of the invention will occur to those skilled in the art. For example, it will be understood that the public information g, d, N, K of the system can be stored on any suitable media, for example a “smart card,” which can be provided with a microprocessor capable of performing arithmetic operations so that the keys can be distributed to and/or from the smart card.

What is claimed is:

1. A method of secure establishment and distribution of encryption/decryption keys among two communicating parties comprising of:
public (non-secret) selecting natural numbers m and n;
public (non-secret) selecting a semi-ring A with the multiplicative unit 1 and the neutral additive element 0 (i.e., A is a set with the operations of addition and multiplication satisfying the distributive, associative, and commutative laws and such that a·1=a, a+0=a, and a·0=0) by both communicating parties;
public (non-secret) selecting a commutative topological monoid X (i.e., X is a topological space equipped with a continuous associative and commutative operation, which is to be referred as addition: (x, y)→x+y, and which has the additive neutral element 0ₓ: 0ₓ+x=x for any x∈X) by both communicating parties;
public (non-secret) selecting a two-sided action of A on X by both communicating parties, i.e., a pair of maps A×X→X and X×A→X (denoted by (a, x)→a(x) and (x, a)→(x)a) such that (a(x))b=a((x)b) and:
a(x+y)=a(x)+a(y), (a+b)(x)=a(x)+b(x), a(b(x))=(a·b)(x), 1(x)=x, a(0ₓ)=0ₓ
(x+y)a=(x)a+(y)a, (x)(a+b)=(x)a+(x)b, ((x)a)b=(x)(a·b), (x)1=x, (0ₓ)a=0ₓ
for any a, b∈A, and x, y∈X);
private (non-public) generating a quadruple (A, C, A′, C′) of m×m matrices A=(aᵢₖ) and C=(cᵢₖ), and n×n matrices A′=(a′lj) and C′=(c′ₗⱼ) with all coefficients in the semi-ring A by the first communicating party; and private (non-public) generating a quadruple (B, D, B′, D′) of m×m matrices B=(aᵢₖ) and D′=(d′ᵢₖ), and n×n matrices B′=(b′ₗⱼ) and D=(dₗⱼ) with all coefficients in the semi-ring A by the second communicating party; it is also required that these eight matrices A, A′, B, B′, C, C′, D, D′ satisfy the equations CB′=D′A and BC′=A′D;
public (non-secret) selecting an m×n matrix g=(gᵢⱼ) with all coefficients in X by both communicating parties;
generating an m×n matrix A(g)A′ by the first communicating party by the formula:
$$A ( g ) {A}^{′} = ( {{g}^{′}}_{ij} ) , \\ where$$
$${{g}^{′}}_{ij} = {\sum }_{k = 1}^{M} {\sum }_{l = 1}^{n} {a}_{ik} ( {g}_{kl} ) {a}_{lj}$$
for i=1, 2, . . . , m, and j=1, 2, . . . , n, where each aᵢₖ is a corresponding matrix coefficient of the matrix A and each a′ₗⱼ is a corresponding matrix coefficient of the matrix A′;
generating an m×n matrix B′(g)B by the second communicating party by the formula:
$${B}^{′} ( g ) B = ( {{g}^{″}}_{ij} ) , \\ where$$
$${{g}^{″}}_{ij} = {\sum }_{k = 1}^{m} {\sum }_{l = 1}^{n} {{b}^{′}}_{ik} ( {g}_{kl} ) {b}_{lj}$$
for i=1, 2, . . . , m, and j=1, 2, . . . , n, where each b′ᵢₖ is a corresponding matrix coefficient of the matrix B′ and each bₗⱼ is a corresponding matrix coefficient of B;
public (non-secret) transmitting the m×n matrix A(g)A′ from the first communicating party to the second communicating party;
public (non-secret) transmitting the m×n matrix B′(g)B from the second communicating party to the first communicating party;
creating the shared secret key D′A(g)A′D=CB′(g)BC′ by the communicating parties: generating the m×n matrix D′(A(g)A′)D by the second communicating party and generating the m×n matrix C(B′(g)B)C′ by the first communicating party (since CB′=D′A and A′D=BC′, both communicating parties possess this secret key D′A(g)A′D=CB′(g)BC′).

2. The method as defined by claim 1, wherein the semi-ring A is constructed out of an arbitrary semi-ring A′ without a neutral additive element 0 as follows: A=A′∪{0} such that a′+0=0+a′=a′ and a′·0=0·a′=a′ for any a′∈A′; 0+0=0 and 0·0=0.

3. The method as defined by claims 1 and 2, wherein the semi-ring A is constructed out of an arbitrary semi-ring A′ with the neutral additive element 0, but without the multiplicative unit 1 as follows: the elements of A are pairs (n, a′), where n is a non-negative integer and a′∈A′, and the operations of addition and multiplication are given by: (m, a′)+(n, b′)=(m+n, a′+b′), (m, a′)·(n, b′)=(m·n, n·a′+m·b′+a′·b′) for any non-negative integers m and n and a′, b′∈A′; the multiplicative unit in A is (1, 0), where 0 is the neutral additive element and 1 is the ordinary natural unit.

4. The method as defined by claim 1, wherein the matrices A′ and C′ are equal to the m×m identity matrix, and the matrices B′ and D′ are equal to the n×n identity matrix, and the equations CB′=D′A and A′D=BC′ from claim 1 are solved by setting C=A, D=B.

5. The method as defined by claims 1 and 4, wherein m=n=2 and the 2×2 matrices g, A, and B are of the form
$$g = [ \begin{matrix}{g}_{11} & {g}_{12} \\ {g}_{21} & {g}_{22}\end{matrix} ]$$
where g₁₁, g₁₂, g₂₁, g₂₂ are public elements of the commutative monoid X;
$$A = [ \begin{matrix}{a}_{11} & {a}_{12} \\ {a}_{21} & {a}_{22}\end{matrix} ] \qquad B = [ \begin{matrix}{b}_{11} & {b}_{12} \\ {b}_{21} & {b}_{22}\end{matrix} ]$$
where a₁₁, a₁₂, a₂₁, a₂₂ are elements of the semi-ring A privately generated by the first communicating party, and b₁₁, b₁₂, b₂₁, b₂₂ are elements of the semi-ring A privately generated by the second communicating party. Therefore,
$$A ( g ) = [ \begin{matrix}{a}_{11} ( {g}_{11} ) + {a}_{12} ( {g}_{21} ) & {a}_{11} ( {g}_{12} ) + {a}_{12} ( {g}_{22} ) \\ {a}_{21} ( {g}_{11} ) + {a}_{22} ( {g}_{21} ) & {a}_{21} ( {g}_{12} ) + {a}_{22} ( {g}_{22} )\end{matrix} ]$$
$$( g ) B = [ \begin{matrix}( {g}_{11} ) {b}_{11} + ( {g}_{12} ) {b}_{21} & ( {g}_{11} ) {b}_{12} + ( {g}_{12} ) {b}_{22} \\ ( {g}_{21} ) {b}_{11} + ( {g}_{22} ) {b}_{21} & ( {g}_{21} ) {b}_{12} + ( {g}_{22} ) {b}_{22}\end{matrix} ]$$
$$And ultimately , \\ A ( ( g ) B ) = [ \begin{matrix}\begin{matrix}{a}_{11} ( ( {g}_{11} ) {b}_{11} + \\ ( {g}_{12} ) {b}_{21} ) + \\ {a}_{12} ( ( {g}_{21} ) {b}_{11} + \\ ( {g}_{22} ) {b}_{21} )\end{matrix} & \begin{matrix}{a}_{11} ( ( {g}_{11} ) {b}_{12} + \\ ( {g}_{12} ) {b}_{22} ) + \\ {a}_{12} ( ( {g}_{21} ) {b}_{12} + \\ ( {g}_{22} ) {b}_{22} )\end{matrix} \\ \begin{matrix}{a}_{21} ( ( {g}_{11} ) {b}_{11} + \\ ( {g}_{12} ) {b}_{21} ) + \\ {a}_{22} ( ( {g}_{21} ) {b}_{11} + \\ ( {g}_{22} ) {b}_{21} )\end{matrix} & \begin{matrix}{a}_{21} ( ( {g}_{11} ) {b}_{12} + \\ ( {g}_{12} ) {b}_{22} ) + \\ {a}_{22} ( ( {g}_{21} ) {b}_{12} + \\ ( {g}_{22} ) {b}_{22} )\end{matrix}\end{matrix} ]$$
$$( A ( g ) ) B = [ \begin{matrix}\begin{matrix}\begin{matrix}\begin{matrix}( {a}_{11} ( {g}_{11} ) + \\ {a}_{12} ( {g}_{21} ) ) {b}_{11} +\end{matrix} \\ ( {a}_{11} ( {g}_{12} ) +\end{matrix} \\ {a}_{12} ( {g}_{22} ) ) {b}_{21}\end{matrix} & \begin{matrix}\begin{matrix}\begin{matrix}( {a}_{11} ( {g}_{11} ) + \\ {a}_{12} ( {g}_{21} ) ) {b}_{12} +\end{matrix} \\ ( {a}_{11} ( {g}_{12} ) +\end{matrix} \\ {a}_{12} ( {g}_{22} ) ) {b}_{22}\end{matrix} \\ \begin{matrix}\begin{matrix}\begin{matrix}( {a}_{21} ( {g}_{11} ) + \\ {a}_{22} ( {g}_{21} ) ) {b}_{11} +\end{matrix} \\ ( {a}_{21} ( {g}_{12} ) +\end{matrix} \\ {a}_{22} ( {g}_{22} ) ) {b}_{21}\end{matrix} & \begin{matrix}\begin{matrix}\begin{matrix}( {a}_{21} ( {g}_{11} ) + \\ {a}_{22} ( {g}_{21} ) ) {b}_{12} +\end{matrix} \\ ( {a}_{21} ( {g}_{12} ) +\end{matrix} \\ {a}_{22} ( {g}_{22} ) ) {b}_{22}\end{matrix}\end{matrix} ]$$
(that is, (A(g))B=A((g)B)=A(g)B, and thus, both communicating parties possess this secret shared key A(g)B).

6. The method as defined by claim 1, wherein n=1, i.e., g is an m-column with coefficients in X and A′, B, C′, D are 1×1-matrices equal to 1 of A, i.e., A′=C′=B=D=1 (so that the quadruple A′, C′, B, D comprises a solution to the equation A′D=BC′ of claim 1).

7. The method as defined by claim 1, wherein the monoid X is constructed out of any semigroup X′ without a neutral additive element 0ₓ as follows: X=X′∪{0ₓ} such that x′+0ₓ=0ₓ+x′=x′ and x′·0ₓ=0ₓ·x′=x′ for any x′∈X′; 0ₓ+0ₓ=0ₓ and 0ₓ·0ₓ=0ₓ.

8. The method as defined by claims 1 and 3, A is the semi-ring of all non-negative integers with the natural operations of addition and multiplication, and the two-sided action of A on X is given by the repeated addition:
a(x)=(x)a=a·x=x+x+ . . . +x
where the latter addition is taken a times for any a∈A and x∈X.

9. The method as defined by claim 1, wherein the monoid X is equal to the additive monoid of the semi-ring A and the two-sided action of A on X is multiplication:
a(x)=(x)a=a·x
for any a, x∈X.

10. The method as defined by claims 1 and 9, wherein the monoid X is the set of all real numbers and the ideal element +∞ with the new operations of addition and multiplication:
x⊕y=min(x, y), x∘y=x+y;
under these operations X has both the multiplicative unit 1=0 and the neutral additive element 0ₓ=+∞ (here we follow the standard convention that x+∞=+∞ and min(x,+∞)=x for any real number x).

11. The method as defined by claim 1, wherein X is an arbitrary commutative topological group.

12. The method as defined by claims 1 and 11, wherein X is any commutative compact topological group.

13. The method as defined by claim 1, wherein X is any connected compact commutative Lie group.

14. The method as defined by claims 1 and 13, wherein the said X is a connected closed commutative subgroup of the orthogonal group O(V), where V is a Euclidean vector space.

15. The method as defined by claim 1, wherein the said X is a connected closed commutative subgroup of the unitary group U(W), where W is a Hermitian vector space.

16. The method as defined by claim 14, wherein the group X is a commutative subgroup of the special orthogonal group SO(V), that is, of the connected component of the identity in the orthogonal group O(V).

17. The method as defined by claim 15, wherein the group X is a commutative subgroup of the unitary group U(W).

18. The method as defined by claim 14, wherein the set V is a Euclidean vector space of dimension p, where p is an integer greater than 1.

19. The method as defined by claim 15, wherein the set W is a Hermitian vector space of dimension p, where p is an integer greater than 0.

20. The method as defined by claim 18, wherein said V is the real vector space R^{p} with the standard Euclidean dot product:
x·y=x₁y₁+x₂y₂30 . . . +xₚyₚ
for any vectors x=[x₁, x₂, . . . , xₚ] and y=[y₁, y₂, . . . , yₚ] of R^{p}.

21. The method as defined by claim 19, wherein the said W is the complex vector space Cⁿ with the standard Hermitian dot product:
x·y*=x₁y₁*+x₂y₂*+ . . . +xₚyₚ*
for any vectors x=[x₁, x₂, . . . , xₚ] and y=[y₁, y₂, . . . , yₚ] of C^{p}, where yᵢ* is the complex conjugate number of the complex number yᵢ.

22. The method as defined by claims 16 and 20, wherein the group X is a closed commutative subgroup of the group SOₚ of special orthogonal p×p matrices (that is, SOₚ is the set of all real p×p matrices M such that the determinant of M is 1 and M·M^{T}=I, where M^{T} is the transposed matrix of M and I is the identity p×p matrix).

23. The method as defined by claims 17 and 21, wherein the group X is a closed commutative subgroup of the group Uₚ of unitary p×p matrices (that is, Uₚ is the set of all complex p×p matrices M such that M·M*=I, where M* is the transposed complex conjugate matrix of M and I is the identity p×p matrix).

24. The method as defined by claims 22 and 23, wherein the group X is any of two isomorphic groups SO₂ or U₁.

25. The method as defined by claims 12 and 24, wherein the group X is a torus of dimension p, that is, X is direct product of p copies of the group U₁.

26. The method of claim 24, wherein as the group X is further defined as the semi-open interval [0, 1) of real numbers that includes 0 but does not include 1, where the group operation is the fractional part of the sum: g·h={g+h} for any real g and h in the semi-open interval [0, 1), where {z} stands for the fractional part of a real number z.

27. The method as defined by claims 1 and 26, wherein the said m×n matrix g=(gᵢⱼ) has the property that all gᵢⱼ are real numbers in the semi-open interval [0,1); and for an integer m×m matrix A=(aᵢₖ) the m×n matrix A(g) is given by:
A(g)={A·g},
and for an integer n×n matrix B=(bₗⱼ) the m×n matrix (g)B is given by:
(g)B={g·B},
where {x} stands for the coefficient-wise fractional part of a real m×n matrix x.

28. The method as defined by claims 1, 5, 26, and 27, wherein n=2 and the 2×2 matrices g, A, and B are given by:
$$g = [ \begin{matrix}{g}_{11} & {g}_{12} \\ {g}_{21} & {g}_{22}\end{matrix} ]$$
where g₁₁, g₁₂, g₂₁, g₂₂ are real numbers in the semi-open interval [0,1);
$$A = [ \begin{matrix}{a}_{11} & {a}_{12} \\ {a}_{21} & {a}_{22}\end{matrix} ] \qquad B = [ \begin{matrix}{b}_{11} & {b}_{12} \\ {b}_{21} & {b}_{22}\end{matrix} ]$$
where a₁₁, a₁₂, a₂₁, a₂₂ are non-negative integers privately generated by the first communicating party, and b₁₁, b₁₂, b₂₁, b₂₂ are non-negative integers privately generated by the second communicating party. Therefore,
$$\{ A \cdot g \} = [ \begin{matrix}\{ {a}_{11} {g}_{11} + {a}_{12} {g}_{21} \} & \{ {a}_{11} {g}_{12} + {a}_{12} {g}_{22} \} \\ \{ {a}_{21} {g}_{11} + {a}_{22} {g}_{21} \} & \{ {a}_{21} {g}_{12} + {a}_{22} {g}_{22} \}\end{matrix} ]$$
$$\{ g \cdot B \} = [ \begin{matrix}\{ {g}_{11} {b}_{11} + {g}_{12} {b}_{21} \} & \{ {g}_{11} {b}_{12} + {g}_{12} {b}_{22} \} \\ \{ {g}_{21} {b}_{11} + {g}_{22} {b}_{21} \} & \{ {g}_{21} {b}_{12} + {g}_{22} {b}_{22} \}\end{matrix} ]$$
$$And ultimately , \\ \{ A \cdot \{ g \cdot B \} \} = [ \begin{matrix}\begin{matrix}\{ {a}_{11} ( {g}_{11} {b}_{11} + \\ {g}_{12} {b}_{21} ) + \\ {a}_{12} ( {g}_{21} {b}_{11} + \\ {g}_{22} {b}_{21} ) \}\end{matrix} & \begin{matrix}\{ {a}_{11} ( {g}_{11} {b}_{12} + \\ {g}_{12} {b}_{22} ) + \\ {a}_{12} ( {g}_{21} {b}_{12} + \\ {g}_{22} {b}_{22} ) \}\end{matrix} \\ \begin{matrix}\{ {a}_{21} ( {g}_{11} {b}_{11} + \\ {g}_{12} {b}_{21} ) + \\ {a}_{22} ( {g}_{21} {b}_{11} + \\ {g}_{22} {b}_{21} ) \}\end{matrix} & \begin{matrix}\{ {a}_{11} ( {g}_{11} {b}_{12} + \\ {g}_{12} {b}_{22} ) {a}_{21} + \\ {a}_{22} ( {g}_{21} {b}_{12} + \\ {g}_{22} {b}_{22} ) \}\end{matrix}\end{matrix} ]$$
$$\{ \{ A \cdot g \} \cdot B \} = [ \begin{matrix}\begin{matrix}\{ ( {a}_{11} {g}_{11} + \\ {a}_{12} {g}_{21} ) {b}_{11} + \\ ( {a}_{11} {g}_{12} + \\ {a}_{12} {g}_{22} ) {b}_{21} \}\end{matrix} & \begin{matrix}\{ ( {a}_{11} {g}_{11} + \\ {a}_{12} {g}_{21} ) {b}_{12} + \\ ( {a}_{11} {g}_{12} + \\ {a}_{12} {g}_{22} ) {b}_{22} \}\end{matrix} \\ \begin{matrix}\{ ( {a}_{21} {g}_{11} + \\ {a}_{22} {g}_{21} ) {b}_{11} + \\ ( {a}_{21} {g}_{12} + \\ {a}_{22} {g}_{22} ) {b}_{21} \}\end{matrix} & \begin{matrix}\{ ( {a}_{21} {g}_{11} + \\ {a}_{22} {g}_{21} ) {b}_{12} + \\ ( {a}_{21} {g}_{12} + \\ {a}_{22} {g}_{22} ) {b}_{22} \}\end{matrix}\end{matrix} ]$$
(so that {A·{g·B}}={{A·g}·B}={A·g·B}, and thus, both communicating parties possess the secret shared secret key {A·g·B}).

29. The method as defined by claim 26, wherein for each natural number P, each element g of the commutative group X is rounded to a rational element [g]_{P} of the group X according to the formula:
[g]_{P}=(Round(gP))/P
if Round(gP)<P, and
[g]_{P}=0
if Round(gP)=P,
where Round(z) stands for the standard rounding of a real number z to the closest integer.

30. The method as defined by claims 26 and 29, wherein for each m×n matrix P=(Pᵢⱼ) of natural numbers, each m×n matrix g=(gᵢⱼ), each coefficient of which is a real number in the semi-open interval [0,1], is rounded to a rational m×n matrix [g]_{P} according to the formula:
[g]_{P}=([gᵢⱼ]_{Pij}).

31. A method of secure distribution of encryption/decryption keys among two communicating parties comprising of:
public (non-secret) selecting natural numbers m and n as in claim 1;
public (non-secret) selecting m×n matrices P=(Pᵢⱼ), Q=(Qᵢⱼ), and K=(Kᵢⱼ);
public (non-secret) selecting the commutative compact topological group X built on the semi-open interval [0,1) as in claim 26;
public (non-secret) selecting an m×n matrix g=(gᵢⱼ) of real numbers in the semi-open interval [0,1) as in claim 26;
private (non-public) generating a quadruple (A, C, A′, C′) of m×m matrices A=(aᵢₖ) and C=(cᵢₖ), and n×n matrices A′=(a′ₗⱼ) and C′=(c′ₗⱼ) with integer coefficients by the first communicating party; and private (non-public) generating a quadruple (B, D, B′, D′) of m×m matrices B=(aᵢₖ) and D′=(d′ᵢₖ), and n×n matrices B′=(b′ₗⱼ) and D=(dₗⱼ) with integer coefficients by the second communicating party; it is also required that these eight matrices A, A′, B, B′, C, C′, D, D′ satisfy the equations CB′=D′A, BC′=A′D;
generating the m×n matrix {A·g·A′} by the first communicating party as in claim 27;
generating the P-rounded m×n matrix [{A·g·A′}]_{P} by the first communicating party as in claim 30;
generating the m×n matrix {B′·g·B} by the second communicating party as in claim 27;
generating the Q-rounded m×n matrix [{B′·g·B}]_{Q} by the second communicating party as in claim 30;
public (non-secret) transmitting the m×n matrix [{A·g·A′}]_{P} from the first communicating party to the second communicating party;
public (non-secret) transmitting the m×n matrix [{B′·g·B}]_{Q} from the second communicating party to the first communicating party;
creating the shared secret key by the communicating parties: generating the m×n matrix [{D′·[{A·g·A′}]_{P}·D}]_{K} by the second communicating party and generating the m×n matrix [{C·[{B′·g·B}]_{Q}·C′}]_{K} by the first communicating party.

32. The method as defined by claims 27, 28, 29, 30, and 31, wherein at least one coordinate of the said m×n matrix g=(gᵢⱼ) is an irrational number.

33. The method as defined by claims 27, 28, 29, 30, and 31, wherein each coordinate gᵢⱼ of the said m×n matrix g=(gᵢⱼ) is a rational number of the form gᵢⱼ=Mᵢⱼ/Nᵢⱼ, where 0≦Mᵢⱼ<Nᵢⱼ.

34. The method as defined by claim 31, wherein m×n matrices of natural numbers P=(Pᵢⱼ), Q=(Qᵢⱼ), and K=(Kᵢⱼ) and the natural number d>1 satisfy the following compatibility conditions: α•Q*•α′≦(d•K)*, β′•P*•β≦(d•K)*, where α=(αᵢₖ) is an arbitrary public (non-secret) m×m matrix with natural coefficients, β=(βₗⱼ) is an arbitrary public (non-secret) n×n matrix with natural coefficients; and P*=(1/Pᵢⱼ), Q*=(1/Qᵢⱼ), (d•K)*=(1/(d•Kᵢⱼ)), and the m×n matrix inequality Y≦Z is equivalent to m•n scalar inequalities: yᵢⱼ≦zᵢⱼ, these compatibility conditions guarantee that for any integer m×m matrices A, B′, C, D′ and any integer n×n matrices A′, B, C′, D satisfying

|cᵢₖ|<αᵢₖ, |dₗⱼ|<βₗⱼ, |d′ᵢₖ|<β′ᵢₖ, |c′ₗⱼ|<α′ₗⱼ
(i, k=1, 2, . . . , m, and j, l=1, 2, . . . , n) and for any real m×n matrix g=(gᵢⱼ) at least one matrix coefficient of [{D′·[{A·g·A′}]_{P}·D}]_{d·K} equals 0, or at least one matrix coefficient of [{C·[{B′·g·B}]_{Q}·C′}]_{d·K} equals 0, or
−(d•K)*<{D′·[{A·g·A′}]_{P}·D}−{C·[{B′·g·B}]_{Q}·C′}<(d•K)*.

35. The method as defined by claim 31, wherein a real m×n matrix x=(xᵢⱼ) is defined to be (K, d)-consistent if:
−c•1ₘₙ≦x−[x]_{K}≦c•1ₘₙ,
where c=½−1/(2d) and 1ₘₙ is the m×n matrix in which all matrix coefficients are equal 1.

36. The method as defined by claims 31, 34, and 35 wherein both m×n matrices {D′·[{A·g·A′}]_{P}·D} and {C·[{B′·g·B}]_{Q}·C′} are (K, d)-consistent, which guarantees the equality of the shared keys: [{D′·[{A·g·A′}]_{P}·D}]_{K}=[{C·[{B′·g·B}]_{Q}·C′}]_{K}.

37. The method as defined by claims 1, 9, and 10 of secure establishment and distribution of encryption/decryption keys among two communicating parties comprising of:
public (non-secret) selecting natural numbers m and n;
private (non-public) generating a quadruple (A, C, A′, C′) of m×m matrices A=(aᵢₖ) and C=(cᵢₖ), and n×n matrices A′=(a′ₗⱼ) and C′=(c′ₗⱼ), which coefficients are either real numbers or +∞, by the first communicating party; and private (non-public) generating a quadruple (B, D, B′, D′) of m×m matrices B=(aᵢₖ) and D′=(d′ᵢₖ), and n×n matrices B′=(b′ₗⱼ) and D=(dₗⱼ), which coefficients are either real numbers or +∞, by the second communicating party; it is required that these eight matrices A, A′, B, B′, C, C′, D, D′ satisfy the equations C∘B′=D′∘A, B∘C′=A′∘D;
public (non-secret) selecting an m×n matrix g=(gᵢⱼ), which coefficients gᵢⱼ are either real numbers or +∞, by both communicating parties;
generating an m×n matrix A∘g∘A′ by the first communicating party by the formula:
$$A ∘ g ∘ {A}^{′} = ( {{g}^{′}}_{ij} ) , \\ where$$
$${{g}^{′}}_{ij} = {min}_{1 \leq k \leq m} {min}_{1 \leq l \leq n} ( {a}_{ik} + {g}_{kl} + {{a}^{′}}_{lj} )$$
for i=1, 2, . . . , m, and j=1, 2, . . . , n, where each aᵢₖ is a corresponding matrix coefficient of the matrix A and each a′ₗⱼ is a corresponding matrix coefficient of the matrix A′;
generating an m×n matrix B′∘g∘B by the second communicating party by the formula:
$${B}^{′} ∘ g ∘ B = ( {{g}^{″}}_{ij} ) , \\ where$$
$${{g}^{″}}_{ij} = {min}_{1 \leq k \leq m} {min}_{1 \leq l \leq n} ( {{b}^{′}}_{ik} + {g}_{kl} + {b}_{lj} )$$
for i=1, 2, . . . , m, and j=1, 2, . . . , n, where each bₗⱼ is a corresponding matrix coefficient of the matrix B and each b′ᵢₖ is a corresponding matrix coefficient of the matrix B′;
public (non-secret) transmitting the m×n matrix A∘g∘A′ from the first communicating party to the second communicating party;
public (non-secret) transmitting the m×n matrix B′∘g∘B from the second communicating party to the first communicating party;
creating the shared secret key D′∘A∘g∘A′∘D=C∘B′∘g∘B∘C′ by the communicating parties: generating the m×n matrix D′∘(A∘g∘A′)∘D by the second communicating party and generating the m×n matrix C∘(B′∘g∘B)∘C′ by the first communicating party (since C∘B′=D′∘A and B∘C′=A′∘D, both communicating parties possess this secret key D′∘A∘g∘A′∘D=C∘B′∘g∘B∘C′).

38. The method as defined by claims 1, 4, 5, and 37 wherein m=n=2 and the 2×2 matrices g, A, and B are of the form
$$g = [ \begin{matrix}{g}_{11} & {g}_{12} \\ {g}_{21} & {g}_{22}\end{matrix} ]$$
where g₁₁, g₁₂, g₂₁, g₂₂ are public real numbers;
$$A = [ \begin{matrix}{a}_{11} & {a}_{12} \\ {a}_{21} & {a}_{22}\end{matrix} ] \qquad B = [ \begin{matrix}{b}_{11} & {b}_{12} \\ {b}_{21} & {b}_{22}\end{matrix} ]$$
where a₁₁, a₁₂, a₂₁, a₂₂ are real numbers privately generated by the first communicating party, and b₁₁, b₁₂, b₂₁, b₂₂ are real numbers privately generated by the second communicating party. Therefore,
$$\begin{matrix}A ∘ g = [ \begin{matrix}min ( {a}_{11} + {g}_{11} , {a}_{12} + {g}_{21} ) & min ( {a}_{11} + {g}_{12} , {a}_{12} + {g}_{22} ) \\ min ( {a}_{21} + {g}_{11} , {a}_{22} + {g}_{21} ) & min ( {a}_{21} + {g}_{12} , {a}_{22} + {g}_{22} )\end{matrix} ] \\ g ∘ B = [ \begin{matrix}min ( {g}_{11} + {b}_{11} , {g}_{12} + {b}_{21} ) & min ( {g}_{11} + {b}_{12} , {g}_{12} + {b}_{22} ) \\ min ( {g}_{21} + {b}_{11} , {g}_{22} + {b}_{21} ) & min ( {g}_{21} + {b}_{12} , {g}_{22} + {b}_{22} )\end{matrix} ] \\ And ultimately , \\ A ∘ g ∘ B = [ \begin{matrix}min ( {a}_{11} + {g}_{11} + {b}_{11} , {a}_{11} + {g}_{12} + {b}_{21} , {a}_{12} + {g}_{21} + {b}_{11} , {a}_{12} + {g}_{22} + {b}_{21} ) & min ( {a}_{11} + {g}_{11} + {b}_{12} , {a}_{11} + {g}_{12} + {b}_{22} , {a}_{12} + {g}_{21} + {b}_{12} , {a}_{12} + {g}_{22} + {b}_{22} ) \\ min ( {a}_{21} + {g}_{11} + {b}_{11} , {a}_{21} + {g}_{12} + {b}_{21} , {a}_{22} + {g}_{21} + {b}_{11} , {a}_{22} + {g}_{22} + {b}_{21} ) & min ( {a}_{21} + {g}_{11} + {b}_{12} , {a}_{21} + {g}_{12} + {b}_{22} , {a}_{22} + {g}_{21} + {b}_{12} , {a}_{22} + {g}_{22} + {b}_{22} )\end{matrix} ]\end{matrix}$$
(that is, both communicating parties possess this secret shared key A∘g∘B).
